(19) United States
(12) Patent Application Publication
(10) Pub. No.: US 2005/0205522 A1
(43) Pub. Date: Sep. 22, 2005

(54) Chemical agent additives in copper CMP slurry

(75) Inventors: Paul Kwok Keung Ho, Singapore (SG); Mei Sheng Zhou, Singapore (SG); Chockalingam Ramasamy, Singapore (SG)

Correspondence Address: George O. Saile, 28 Davis Avenue, Poughkeepsie, NY, 12603, US

(73) Assignee: CHARTERED SEMICONDUCTOR MANUFACTURING LTD.

(21) Appl. No.: 11/130,377

(22) Filed: May 16, 2005

Related U.S. Application Data
(63) Continuation of application No. 09/518,204, filed on Mar. 3, 2000, now abandoned.

(51) Int. Cl. C23F 1/00; B44C 1/22

(52) U.S. Cl. 216/88; 216/89; 438/692

(57) ABSTRACT

A polishing method is achieved comprising the following steps. A layer made of material containing a metal as a main component over a substrate having recessed portions on a surface thereof so as to fill the recessed portions with the metal layer is formed. The metal is Cu, a Cu alloy, Al, or an Al alloy. The metal layer is polished by a chemical mechanical polishing method using a slurry including a polishing agent. The polishing agent contains a chemical agent and an etching agent. The chemical agent includes at least a carbonyl derivative of benzotriazole and is responsible for forming a protective film on the surface of the metal layer by reacting with the material containing a metal as a main component. The etching agent is responsible for etching the material containing a metal as a main component.

### FIELD OF THE INVENTION

The present invention relates generally to a chemical mechanical polishing (CMP) polishing method, and more specifically to a polishing method using a polishing agent for use in CMP of a semiconductor device in a micro-processing step.

### BACKGROUND OF THE INVENTION

Chemical mechanical polishing (CMP) is used to planarize various levels of multi-layered semiconductor devices to permit the smaller designs used to fabricate ever miniaturized semiconductor devices. For example, CMP is used to form planar interlayer insulating films, buried wiring portions and metal plugs. As copper (Cu) begins to replace aluminum (Al) as a wiring material due to copper's lower resistivity, the difficulty of working with Cu requires the use of CMP methods versus reactive-ion etching.

Recently, benzotriazole (C₆H₅N₃) (BTA) (See FIG. 1A) has been used for copper CMP due to benzotriazole's ability to form a protective polymeric layer of Cu (I) BTA. This helps to reduce to polishing rate of the Cu. However, Cu is so soft that the polishing rate is still fast, causing dishing and non-uniform surfaces of the planarized copper.

For example, U.S. Pat. No. 5,770,095 to Sasaki et al. describes a CMP method which uses the polishing agent consisting of a chemical agent, BTA e.g., responsible for forming a protective film (e.g. Cu (I) BTA) on a film surface made of metal (e.g. Cu)-dominant material so as to fill the recessed portions of the film surface, by reacting with the metal-dominant material, and an etching agent for the metal-dominant material. A conductive film is thus formed in the recessed portions while suppressing dishing and scratching of the metal (e.g. Cu). Tryltriazole (TTA) (See FIG. 1B), a BTA derivative whose hydrogen portion is substituted by an alkyl group (i.e.—CH₃), is particularly preferable as the chemical agent for Cu CMP.

U.S. Pat. No. 5,575,885 to Hirabayashi et al. describes a copper-based metal polishing solution which hardly dissolves a Cu film or a Cu alloy film when the film is dipped into the solution, and has a dissolution velocity during polishing several times higher than that during dipping. The copper-based metal polishing solution contains at least one organic acid selected from the group consisting of aminoacetic acid and amidosulfuric acid; an oxidizer; and water.

U.S. Pat. No. 5,897,379 to Ulrich et al. describes a system and method for the low temperature cleaning of copper contaminants from an IC (integrated circuit) wafer which prevents the formation of copper oxides. Diluted nitric acid and an edge bead removal tool are used to remove copper from the perimeter of a semiconductor wafer. One embodiment covers sensitive areas of the wafer with photoresist with the wafer perimeter cleared of the photoresist before application of the acid. A second embodiment protects the sensitive areas of the wafer with a water spray as the acid is applied. In a third embodiment, the nitric acid is applied to clear the wafer perimeter of copper before a CMP is performed on a layer of deposited copper used to protect copper interconnection structures from reacting with the nitric acid.

U.S. Pat. No. 4,251,384 to Rooney describes adding an aromatic ring compound in which at least 2 hetero atoms aluminum polishing solutions that inhibit etched finishes containing phosphoric, nitric, and sulphuric acids.

The article entitled “Copper Corrosion With and Without Inhibitors,” by V. Brusic, M. A. Frisch, B. N. Eldridge, F. P. Novak, F. B. Kaufman, B. M. Rush, and G. S. Frankel; J. Electrochem. Soc., Vol. 138, No. 8, August 1999; pp. 2253-2259 describes a study of the capacity of 1H-benzotriazole (1H-BTA) to provide a protective and stable surface film able to withstand harsh chemical and thermal environments. The best corrosion protection was found to be by a thin Cu-BTA film formed on an oxidized copper surface.

The article entitled “A Photoemmission Study of Benzotriazole on Clean Copper and Cuprous Oxide; by B. S. Fang, C. G. Olson, and D. W. Lynch, Surface Science, 176 (1986); pp. 476-490 describes a proposed model for the geometry and bonding of chemisorbed BTA which accounts for its corrosion inhibition on Cu, and for the corrosion inhibition, or lack of inhibition, by molecules to BTA.

The article entitled “Adsorption and film growth of BTA on clean and oxygen adsorbed Cu(110) surfaces;” by K. Cho, J. Kishimoto, T. Hashizume, H. W. Pickering, and T. Sakurai; Applied Surface Science; 87/88 (1995); pp. 380-385 describes the scanning tunneling microscopy (STM) determination of the different phases of BTA as formed on a clean Cu(110)-1×1 surface [i.e., the c(4×2) commensurate phase] and as adsorbed of the oxygen-induced Cu(110)-2×1 surface [i.e., a fully disordered structure].

### SUMMARY OF THE INVENTION

Accordingly, it is an object of the present invention to provide a Cu CMP slurry that reduces dishing and non-uniform surfaces.

Another object of the present invention is to provide a wide range of Cu CMP slurry chemical agent additives so as to suit the desired CMP process.

A further object of the present invention is to passivate the Cu surface after the CMP and the post-CMP cleaning processes.

Other objects will appear hereinafter.

It has now been discovered that the above and other objects of the present invention may be accomplished in the following manner. Specifically, a layer made of material containing a metal as a main component over a substrate having recessed portions on a surface thereof so as to fill the recessed portions with the metal layer is formed. The metal is Cu, a Cu alloy, Al or an Al alloy. The metal layer is polished by a chemical mechanical polishing method using a slurry including a polishing agent. The polishing agent contains a chemical agent and an etching agent. The chemical agent includes at least a carbonyl derivative of benzotriazole and is responsible for forming a protective film on the surface of the metal layer by reacting with the material containing a metal as a main component. The etching agent is responsible for etching the material containing a metal as a main component.

### BRIEF DESCRIPTION OF THE DRAWINGS

The features and advantages of the CMP polishing method according to the present invention will be more clearly understood from the following description taken in conjunction with the accompanying drawings in which like reference numerals designate similar or corresponding elements, regions and portions and in which:

FIGS. 1A and 1B illustrate the benzotriazole (BTA) and tryltriazole (TTA) compounds, respectively.

FIGS. 2A and 2B illustrate the synthetic routes of formation of carbonyl derivatives of benzotriazole of the present invention.

FIG. 2C illustrates [some of] the —R group of the carbonyl derivatives of benzotriazole of the present invention.

FIG. 3 is a flow chart of the polishing method of the present invention.

FIGS. 4A-4C show a series of schematic cross-sectional diagrams illustrating the results of progressive stages, corresponding to the flow chart of FIG. 3, in the CMP polishing of a metal layer deposited over a substrate having recessed portions on its surface so as to fill the recessed portions in the substrate with the metal layer, in accordance with the present invention.

FIG. 5 schematically illustrates steric blocking of the Cu(I)BTA carbonyl derivative complexes on the surface of a Cu film.

### DETAILED DESCRIPTION OF THE PREFERRED EMBODIMENT

It is important when forming via holes, contact holes, or buried metal wiring portions by polishing a substrate that has protruding and recessed portions that only the protruding portions are polished so as to leave a desired film only in the recessed portions. If only mechanical polishing is used then the desired effect of having the film remaining only in the recessed portions is efficiently achieved ensuring a high selective ratio. However, the throughput necessary in a semiconductor device manufacturing step cannot be ensured due to the low polishing rate of mechanical polishing. If only chemical polishing is used instead of mechanical polishing then the film fails to remain only in the recessed portions and the desired effect is not achieved despite a high polishing rate since etching proceeds isotropically, i.e. the etching process attacks the layer surface equally in all directions.

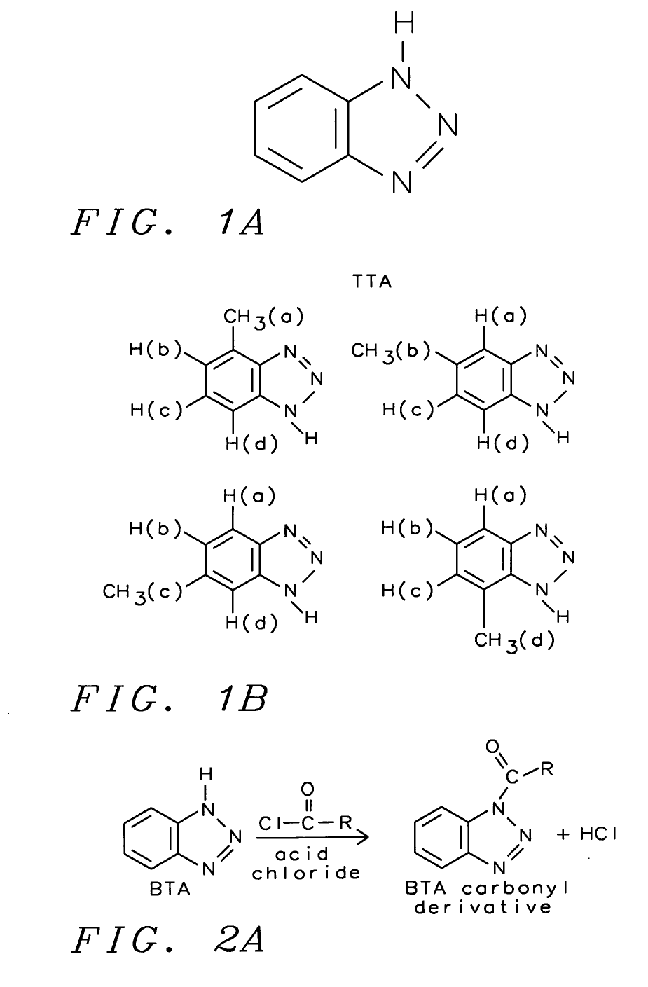

Thus a combination of mechanical and chemical polishing, i.e. chemical mechanical polishing (CMP), is used to achieve the desired effect of having the film remaining only in the recessed portions of the substrate. While the U.S. Pat. No. 5,770,095 to Sasaki et al. (hereinafter the Sasaki patent) discloses using benzotriazole (C₆H₅N₃) (BTA) (See FIG. 1A) or tryltriazole (C₇H₇N₃) (TTA) (See FIG. 1B for its four variations), or a mixture of BTA and TTA, among others, as a chemical agent specific to the material of the target film within a CMP polishing agent so as to form a protective film on the target film to suppress the isotropic chemical polishing, the present inventors have discovered that when copper (Cu) is polished by CMP with BTA and/or TTA, the protection of Cu is still not enough that causes Cu dishing and non-uniform Cu surfaces. Use of BTA and/or TTA, for example in accordance with the Sasaki Patent, in a CMP method causes formation of Cu(I)BTA Cu surface complexes that is the protective film that suppresses the isotropic chemical polishing.

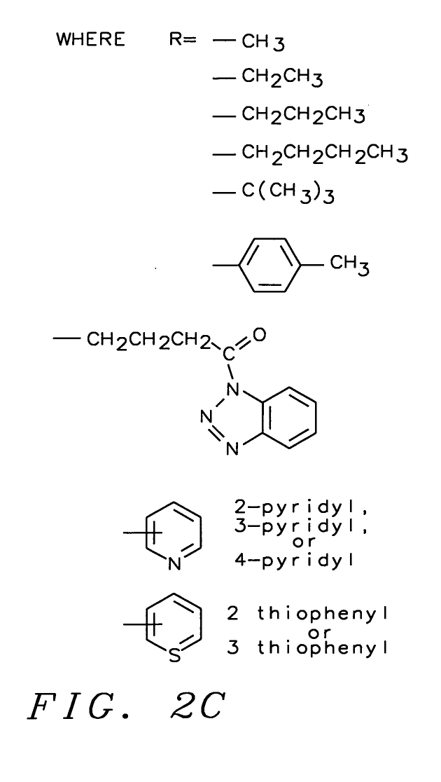

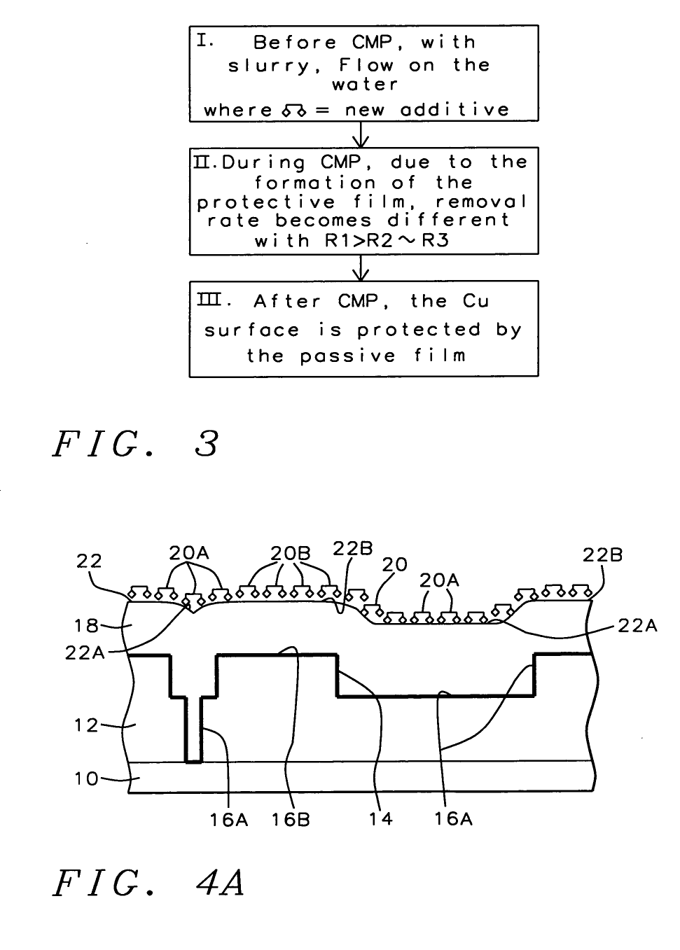

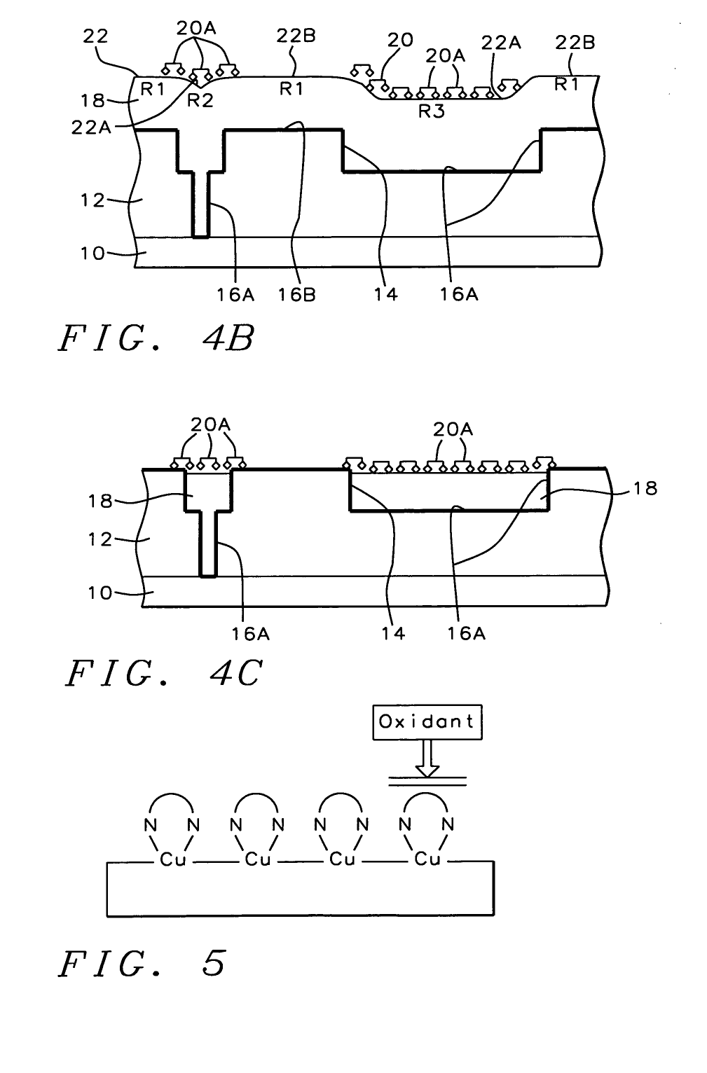

The present inventors have discovered that by using carbonyl derivatives of benzotriazole as a chemical agent in a polishing agent within a CMP slurry instead of benzotriazole (or tryltriazole (TTA)), greater Cu protection capability is achieved over just BTA. This is postulated to be primarily due to the increase of steric bulkiness and hydrophobicity of the substituted carbonyl group, thereby blocking oxidants from the Cu by the sterically bulky and/or hydrophobic carbonyl group of the BTA-carbonyl ligands. (See FIG. 5) The flow chart of FIG. 3 should be referred to in conjunction with FIGS. 4A-4C that schematically illustrate the steps of the present invention's Cu CMP method.

Accordingly as shown in FIG. 4A, starting semiconductor structure 10 is understood to possibly include a semiconductor wafer or substrate, active and passive devices formed within the wafer, conductive layers and dielectric layers (e.g., inter-poly oxide (IPO), intermetal dielectric (IMD), etc.) formed over the wafer surface. The term “semiconductor structure” is meant to include devices formed within a semiconductor wafer and the layers overlying the wafer. Unless otherwise specified, all structures, layers, etc. may be formed or accomplished by conventional methods known in the prior art.

Overlying semiconductor structure 10 is dielectric layer 12 which may be an interlevel dielectric (ILD) or an intermetal dielectric (IMD) having depressions 14 for, for example, via holes, contact holes or metal wiring portions. Barrier layer 16 is deposited over dielectric layer 12 coating depressions 14 at 16A and the upper surface of dielectric layer 12 at 16B. Barrier layer 16 may be comprised of titanium nitride (TiN) or tantalum nitride (TaN) for example. Metal layer 18, consisting of Cu or a Cu alloy, such as Al/Cu. for example, is deposited over barrier layer 16 lined dielectric layer 12. For purposed of example, metal layer 18 will be considered to be comprised of Cu and barrier layer 16 will be considered to be comprised of TaN. Upper surface 22 of Cu layer 18 undulates corresponding to the underlying flat barrier lined 16B upper surface of dielectric layer 12, at 22B, and barrier lined 16A depressions 14, at 22A, within dielectric layer 12.

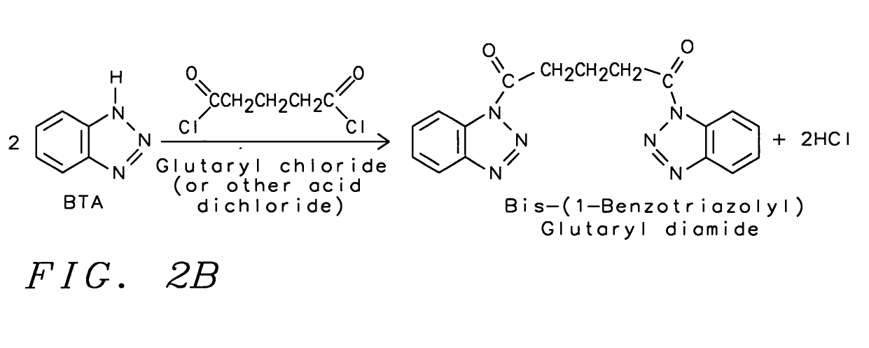

The CMP slurry of the present invention includes a polishing agent that includes at least one carbonyl derivatives of benzotriazole as the chemical agent (with 1-benzotriazolyl-1-butamido preferred), and an etching agent. The etching agent may be comprised of: an oxidizer such as H₂O₂, KIO₃, Fe³⁺, etc.; an acid or base such as HF, etc., or (CH₃)N(OH), etc.; and a buffering agent or organic amine such as NH₄(CH₃CO₂), alkanol amine, amino acid, etc. The carbonyl derivatives of benzotriazole of the present invention are synthesized as shown in FIGS. 2A and 2B.

As shown in FIG. 2C, the “—R” group of the benzotriazole carbonyl derivatives (cdBTA) may be:
methyl —CH₃;
ethyl —CH₂CH₃;
propyl —CH₂CH₂CH₃;
n-butyl —CH₂CH₂CH₂CH₃;
tert-butyl —C(CH₃)₃;
p-tolyl: 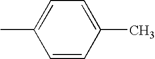
1-benzotriazolyl-1-butamido: 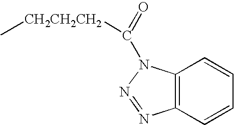
2-pyridyl, or 3-pyridyl, or 4-pyridyl: 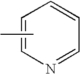
2-thiophenyl or 3-thiophenyl 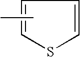
   allowing a wide range of cdBTA compounds that may be used. Many other —R groups may be used. In principal, any acid chloride compounds should be able to react with BTA to form amide. The criteria to selecting R groups are:
1. increase steric effect;
2. increase hydrophobicity; and
3. increase affinity to Cu and thus prevent Cu from, being attacked.

The BTA and acid chloride used to synthesize the compounds disclosed in this invention are commercially available compounds. The BTA carbonyl derivatives so synthesized are not commercially available and can not be found in most of the organic compound handbooks such as the Merck Index.

However, anyone skilled in the art of organic synthesis will be able to synthesize the BTA carbonyl derivatives of the present invention since anyone so skilled in the organic synthesis art will know how to synthesize organic amides (the BTA carbonyl derivative) from amine (BTA) and acid chloride (the Cl—(C═O)—R of FIG. 2A). The reaction conditions may need to be fine-tuned for the specific BTA carbonyl derivative desired as would be known by one skilled in the organic synthesis art.

For example, the following method may be used in the formation of the BTA carbonyl derivatives illustrated in FIG. 2A and Bis-(1-Benzotriazolyl) Glutaryl diamide as illustrated in FIG. 2B as noted. One-tenth (0.1) of a mole (11.91 g) of BTA is dissolved in 100 ml of CHCl₃ (or another organic solvent such as CH₂Cl₂, CCl₄, benzene, toluene, etc.) with 0.2 mole (excess) of triethylamine (or another organic tertiary amine may be used such as pyridine, for example) with mechanical stirring to form the BTA solution.

One-tenth (0.1) of a mole of acid chloride of FIG. 2A (or 0.05 mole in the case of Glutaryl chloride of FIG. 2B or other acid dichlorides) is then added drop wise (usually in liquid form) into the BTA solution with continuous stirring.

External cooling is necessary if heat evolves during the reaction. After the addition of all the acid chloride (or Glutaryl chloride or other acid dichloride) and any heat subsides, the reaction mixture is refluxed for 8 hours. The carbonyl derivative formed can be purified by extraction with a CHCl₃/NaOH (aq) mixture and then recrystallized by cyclohexane or petroleum ether.

The following are example characteristics of the CMP slurry and does not limit the application of the cdBTA to any kind of slurry or any processing condition:
composition:
   1. cdBTA
   2. etching solution (as described above)
   3. abrasive (either alumina or silica)
slurry flow: from about 30 to 300 ml/min
process temperature: from about 5 to 30° C.
polish pressure: from about 0.5 to 10 psi
back pressure: from about 0.5 to 10 psi
platen speed: from about 0.1 to 10 m/s (linear velocity)
CMP polishing rate of Cu layer 18: from about 50 to 1000 nm/min.
CMP polishing rate of TaN barrier layer 16B: from about 10 to 50 nm/min.

Before the CMP polishing of Cu layer 18 commences but with slurry flow on the wafer, the selected chemical agent benzotriazole carbonyl derivative (cdBTA)/mixture is exposed to copper layer 18. Cu on copper layer 18, or Cu(I) oxide, or Cu(II) oxide which are naturally oxidized films formed on the Cu surface, reacts with the benzotriazole carbonyl derivative forming a secure film 20 made of a Cu chelate compound, or BTA-carbonyl ligand, shorthanded by Cu(I)-cdBTA (or Cu(II)-cdBTA), on Cu layer 18 (cdBTA=benzotriazole carbonyl derivative). Those Cu(I)-cdBTA Cu chelate compounds in Cu(I)-cdBTA film 20 in the depressions 22A of undulating Cu layer 18 are denoted at 20A and those Cu(I)-cdBTA Cu chelate compounds in Cu(I)-cdBTA film 20 in the protruding portions 22B of undulating Cu layer 18 are denoted at 20B. The amount of cdBTA necessary for protecting Cu layer 18 may be a very small weight percentage of the total slurry, i.e. from about 0.001 wt. % to 10 wt. % of the polishing agent and more preferably from about 0.01 wt. % to 5.00 wt. %.

As shown in FIG. 4B, as the Cu CMP commences the portions of cdBTA film 20 overlying the protruding portions 22B of Cu layer 18, i.e. at 20B and proximate R1, are easily removed by the mechanical action of the CMP (i.e. exposure to polishing grains or a polishing pad) leaving the portions of cdBTA film 20 overlying, and protecting, the recessed portions 22A of Cu layer 18, i.e. at 20A proximate R2 and R3. Thus the exposed protruding portions 22B of Cu layer 18 at R1 can be eaten away by an etching agent at a high rate while the Cu layer 18 in the recessed portions 22A at R2 and R3 is barely etched since the protection film at 20A is formed on the Cu surface. The reduction of the polishing rate at recessed area 22A during the bulk processing is due to the chemical/physical adsorption of the BTA-carbonyl ligands. Therefore the relative removal rates of Cu layer 18 at R1, R2, and R3 is
R1>R2˜R3
and the CMP polishing of Cu layer 18 was carried out at a rate of from approximately 50 to 1000 nm/min.

As shown in FIG. 4C, to form the buried Cu-wiring portions and Cu plugs, all of the protruding portions 22B of Cu layer 18 must be removed as well as the TaN barrier layer portions 16B on the upper surface of dielectric layer 12. The CMP polishing of TaN barrier layer was carried out at a rate of from approximately 10 to 50 nm/min. When Cu layer 18 at 22A is polished deeper than TaN barrier layer portions 16B, Cu layer 18 at 22A is recessed compared to TaN barrier layer and a cdBTA protection film at 20A was formed over the surface of Cu layer 18 in the depressions of dielectric layer 12 at 20A protecting planarized Cu plug and buried wiring 18 and will enhance the selectivity of Ta/Cu to oxide (dielectric layer 12).

The method of the present invention using a carbonyl derivative of benzotriazole (cdBTA) was found to have better Cu protection than using BTA by anodic stripping voltammetry and the dishing and non-uniformity of Cu CMP was improved.

The improvement in the dishing and non-uniformity of Cu CMP as determined by the Cu dissolution rate. CdBTA has a higher protection power than BTA alone because the resulting Cu dissolution rate is lower (refer to the table below):

| | Corrosion rate | Relative rate |
|---|---|---|
| CdBTA added | (ng/h/cm² Cu surface)* | of corrosion |
| no cdBTA | 467.6 | 100.0 |
| BTA | 175.6 | 37.6 |
| cdBTA, R = CH₃ | 172.9 | 37.0 |
| cdBTA, R = CH₃CH₂ | 120.4 | 25.7 |
| cdBTA, R = CH₃CH₂CH₂ | 133.0 | 28.4 |
| cdBTA, R = CH₃CH₂CH₂CH₂ | 268.9 | 57.5 |
| cdBTA, R = (CH₃)₃C | 119.9 | 25.6 |
| cdBTA, R = p-tolyl | 110.2 | 23.6 |
| cdBTA, R = 1- | 46.5 | 9.9 |
| Benzotriazolyl-1- | | |
| butamido | | |

*nanograms/hour/square centimeter copper surface

While particular embodiments of the present invention have been illustrated and described, it is not intended to limit the invention, except as defined by the following claims.

1. A polishing method comprising the steps of:
forming a layer made of material containing a metal as a main component over a substrate having recessed portions on a surface thereof so as to fill said recessed portions with said metal layer; and
polishing said metal layer by a chemical mechanical polishing method using a slurry including a polishing agent containing
a chemical agent being responsible for forming a protective film on the surface of said metal layer by reacting with said material containing a metal as a main component, wherein said chemical agent includes at least a carbonyl derivative of benzotriazole, and
an etching agent being responsible for etching said material containing a metal as a main component; wherein said etching agent includes an HF acid.

2. The method of claim 1, wherein said carbonyl derivative of benzotriazole has the formula 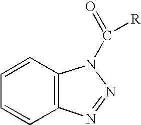
where R is —CH₃ (methyl), —CH₂CH₃ (ethyl), —CH₂CH₂CH₃ (propyl), —CH₂CH₂CH₂CH₃ (n-butyl), —C(CH₃)₃ (tert-butyl), p-tolyl, 1-Benzotriazolyl-1-butamido, 2-pyridyl, 3-pyridyl, 4-pyridyl, 2-thiophenyl or 3-thiophenyl.

3. The method of claim 1, wherein said etching agent further includes an oxidizer and a buffering agent or organic amine.

4. The method of claim 1, wherein said etching agent includes an H₂O₂, KIO₃ or Fe³⁺ oxidizer; and a buffering agent or organic amine that is NH₄(CH₃CO), an alkanol amine or an amino acid.

5. The method of claim 1, wherein said carbonyl derivative of benzotriazole comprises from about 0.0001 to 10 weight % of said polishing agent.

6. The method of claim 1, wherein said carbonyl derivative of benzotriazole comprises from about 0.01 to 5.00 weight % of said slurry.

7. The method of claim 1, wherein said metal is Cu, a Cu alloy, Al, or an Al alloy.

8. A polishing method comprising the steps of:
forming a film made of material containing a metal as a main component over a substrate having recessed portions on a surface thereof so as to fill said recessed portions with said film; and
polishing said film by a chemical mechanical polishing method using a slurry including a polishing agent containing
a chemical agent being responsible for forming a protective film on the surface of said film by reacting with said material containing a metal as a main component, and
an etching agent being responsible for etching said material containing a metal as a main component; wherein said etching agent includes an HF acid;
thereby forming a conductive film in said recessed portions,
wherein said metal is Cu or a Cu alloy and said chemical agent includes at least a carbonyl derivative of benzotriazole.

9. The method of claim 8, wherein said carbonyl derivative of benzotriazole has the formula 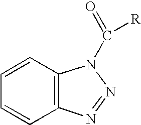
where R is —CH₃ (methyl), —CH₂CH₃ (ethyl), CH₂CH₂CH₃ (propyl), —CH₂Cl₂CH₂CH₃ (n-butyl), —C(CH₃)₃ (tert-butyl), p-tolyl, 1-Benzotriazolyl-1-butamido, 2-pyridyl, 3-pyridyl, 4-pyridyl, 2-thiophenyl or 3-thiophenyl.

10. The method of claim 8, wherein said etching agent further includes an oxidizer and a buffering agent or organic amine.

11. The method of claim 8, wherein said etching agent includes an H₂O₂, KIO₃ or Fe³⁺ oxidizer; and a buffering agent or organic amine that is NH₄(CH₃CO₂), an alkanol amine, or an amino acid.

12. The method of claim 8, wherein said carbonyl derivative of benzotriazole comprises from about 0.0001 to 10 weight % of said slurry.

13. The method of claim 8, wherein said carbonyl derivative of benzotriazole comprises from about 0.01 to 5.00 weight % of said slurry.

14. A polishing method comprising the steps of:
forming a film made of material containing a metal as a main component over a substrate having recessed portions on a surface thereof so as to fill said recessed portions with said film; and
polishing said film by a chemical mechanical polishing method using a slurry including a polishing agent containing
a chemical agent being responsible for forming a protective film on the surface of said film by reacting with said material containing a metal as a main component, and
an etching agent being responsible for etching said material containing a metal as a main component; wherein said etching agent includes an HF acid;
thereby forming a conductive film in said recessed portions,
wherein said metal is Cu or a Cu alloy and said chemical agent includes at least a carbonyl derivative of benzotriazole having the formula 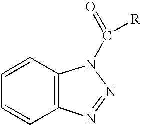
where R is —CH₃ (methyl), —CH₂CH₃ (ethyl), CH₂CH₂CH₃ (propyl), —CH₂CH₂CH₂CH₃ (n-butyl), —C(CH₃)₃ (tert-butyl), p-tolyl, 1-Benzotriazolyl-1-butamido, 2-pyridyl, 3-pyridyl, 4-pyridyl, 2-thiophenyl or 3-thiophenyl.

15. The method of claim 14, wherein said etching agent further includes an oxidizer and a buffering agent or organic amine.

16. The method of claim 14, wherein said etching agent includes an H₂O₂, KIO₃ or Fe³⁺ oxidizer and a buffering agent or organic amine that is NH₄(CH₃CO₂), an alkanol amine, or an amino acid.

17. The method of claim 14, wherein said carbonyl derivative of benzotriazole comprises from about 0.0001 to 10 weight % of said slurry.

18. The method of claim 14, wherein said carbonyl derivative of benzotriazole comprises from about 0.01 to 5.00 weight % of said slurry.
